(19) United States
(12) Patent Application Publication
(10) Pub. No.: US 2020/0032968 A1
(43) Pub. Date: Jan. 30, 2020

(54) Pole Light

(71) Applicant: ROBERT Nichols HOLDEN, Jeffersonville, VT (US)

(72) Inventor: ROBERT Nichols HOLDEN, Jeffersonville, VT (US)

(21) Appl. No.: 15/980,544

(22) Filed: Jul. 28, 2018

(51) Int. Cl. F21L 4/02; F21L 4/04; F21V 23/04; F21V 23/00; F21V 31/00

(52) U.S. Cl. CPC F21L 4/02; F21L 4/04; F21Y 2115/10; F21V 23/004; F21V 31/00; F21V 23/04

(57) ABSTRACT

This device was brought about for the need to help in illuminating work areas where details could be overlooked when a bright lighting is unavailable. The ease of use, the multiple applications, light weight, brightness and longevity of the battery life make this a very unique and useful tool enhancer.

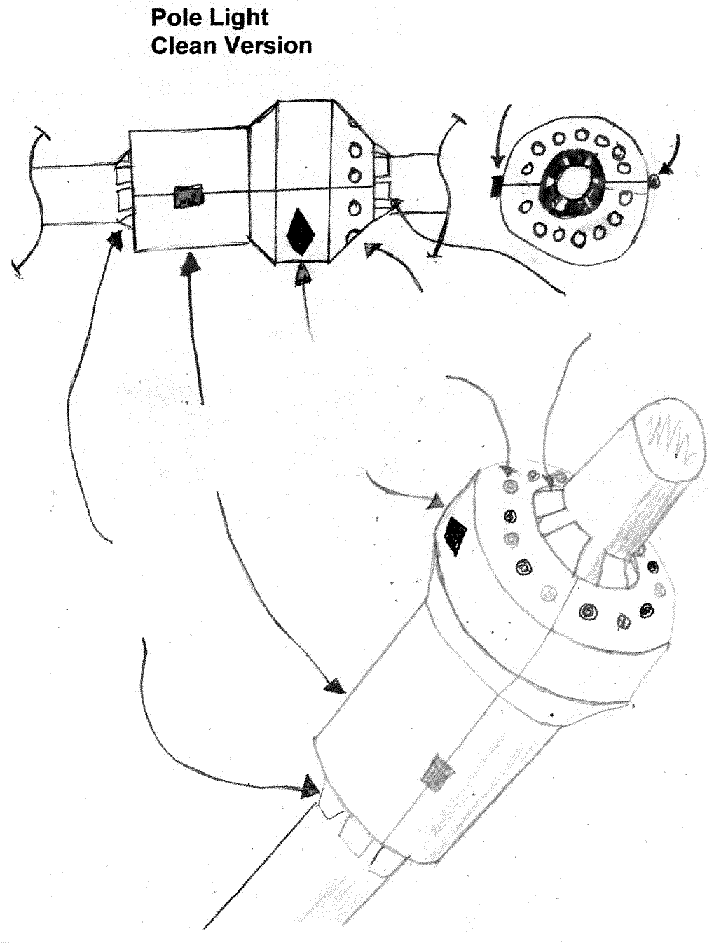

No related applications

No Federally sponsored research or development

No parties to joint research agreements

No Sequence listing

No prior disclosures

### BACKGROUND OF INVENTION

This was developed to help the construction worker to illuminate their work. Most notably the sander of a sheetrock installation. This light, being attached to end of a sanding pole, helps to see imperfections in the sheetrock compound so they can be lightly sanded out before the application of paint makes them stand out. With many other uses including paint rollers on poles, brooms or any other need involving a pole and needed lighting.

### SUMMARY OF INVENTION

The Pole Light is a tubular shaped molded plastic body which opens along its length. A Pole, handle or such is placed inside and then it closes around the pole with grabbers that adjust to various pole diameters. There is a LED band of lights around the front end which illuminates in a 360′ field of view. This beam can be adjusted by sliding the Pole Light forward and backwards on the pole to make the lit circle larger or smaller as needed. It is powered by 3 AA batteries in a convenient spot behind the forward section. The light is controlled by a switch in the forward section of the Pole Light.

### BRIEF DESCRIPTION OF DRAWINGS

The Sketch shows the basics of concept. The lit end, individual LED's. MY prototype has individual LED's In a dome shaped head that places the LED's at a 25 degree angle for maximizing the lit area. This forward section also houses the on/off switch. The rear part is for stability, when clamped to pole, a solid no slip contact and to hold the batteries.

1. I, Robert Nichols Holden, have researched the Pole light in the USPTO database and have found no other patents of its equal. I therefore claim that this invention to be justifiable in its authenticity and originality. Furthermore, the pole light is a multiple use Utility invention for lighting dark and dimly lit work areas with the attachment of the device onto sanding poles, painting poles or other tools that use a handle of various diameters to accomplish tasks. The pole lights ease of use with quick attachment and adjustment for the beams focus for the task to be completed.
